(19) United States
(12) Patent Application Publication
(10) Pub. No.: US 2014/0020723 A1
(43) Pub. Date: Jan. 23, 2014

(54) MAT CLEANING SYSTEM

(71) Applicant: James Murphy, Annandale, NJ (US)

(72) Inventor: James Murphy, Annandale, NJ (US)

(21) Appl. No.: 13/940,876

(22) Filed: Jul. 12, 2013

Related U.S. Application Data
(60) Provisional application No. 61/670,762, filed on Jul. 12, 2012.

(51) Int. Cl. B08B 3/02; B08B 1/02

(52) U.S. Cl. CPC B08B 3/022; B08B 1/02
USPC 134/104.2; 15/77

(57) ABSTRACT

The invention pertains to a self-contained modular system for cleaning porous mats. The cleaning comprises: a housing having a top and bottom orientation and having a front face defining at least an inlet; at least one conveyor in the housing having an upstream and downstream orientation and having an upstream end disposed at the inlet; a solvent application mechanism downstream of the upstream end for applying solvent to the mat; and a basin under at least a portion of the conveyor for collecting solvent and debris falling from the mat. The conveyor is configured to draw the mat into the housing edge-wise, and the downstream end is positioned in relation to an outlet such that the mat is channeled though the outlet as it exits the downstream end.

### CROSS REFERENCE TO RELATED APPLICATIONS

This application claims priority to U.S. Provisional Application No. 61/670,762 filed Jul. 12, 2012, the entire disclosure of which is hereby incorporated herein by reference.

### FIELD OF INVENTION

The present invention relates, generally, to a cleaning apparatus for mats, and, more specifically, to a self-contained, automated system for cleaning personal mats, such as yoga mats.

### BACKGROUND OF INVENTION

Yoga is increasing in popularity as a means of both physical exercise and mental relaxation. Because many yoga exercises are performed on the floor, it is common and often necessary for yoga participants to use a yoga mat. A yoga mat is typically two to three feet wide and five to seven feet long. It has a number of properties to make it both comfortable and useful as a platform on which to perform yoga exercises. For example, a yoga mat typically comprises a compliant material that absorbs energy and otherwise cushions the user from the floor. Additionally, the yoga mat is typically textured to provide a non-skid surface on which the user can perform the exercises. Furthermore, because yoga tends to involve significant physical exertion, typically resulting in the user perspiring, the yoga mats are typically made of an absorbent material to absorb the perspiration to prevent the mat from becoming slippery and, thus, ineffective for yoga exercises. Although a variety of different materials can be used that have these properties, often, natural rubber is used as a preferred yoga mat material.

The same physical properties that make a particular material useful as a yoga mat also contribute to the difficulty in keeping the mat clean and sanitary. Specifically, because the mats are configured to absorb perspiration, after prolonged use, the mats become infiltrated with bacteria commonly associated with human perspiration. Additionally, because the mats are used on the floor and repeatedly stepped on by the user, the non-skid texture of the mat tends to hold in dirt and other debris. Having a yoga mat that is infested with bacteria and infiltrated with debris is obviously undesirable. Dirt, debris and bacteria can not only generate an offensive odor, but also present significant health risks, including skin rashes and infections.

While some mat cleaners use UV light to kill germs, such an approach ignores the problem of the dirt and debris embedded in the mats. Additionally, excessive exposure to UV light tends to degrade mat materials, like natural rubber. Consequently, users are often forced to take their mats home from the yoga facility and wash them in a bathtub or outside with a hose. Obviously, the task of taking the mat home and cleaning it under these conditions adds inconvenience and complexity to an activity intended to be relaxing and enjoyable.

Therefore, Applicant has identified the need for a yoga mat cleaner that both cleans and sanitizes the yoga mat, that is simple and self-contained, and that is resident on the premises of the yoga instruction. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides for a self-contained modular cleaning system that can be located at the yoga instructional facilities and merely plugged into a wall using an ordinary residential voltage. In one embodiment, the system comprises: (a) a housing having a top and bottom orientation and having a front face defining at least an inlet; (b) at least one conveyor in the housing having an upstream and downstream orientation and having an upstream end disposed at the inlet, the conveyor configured to draw the mat into the housing edge-wise, the conveyor having a downstream end positioned in relation to an outlet such that the mat is channeled though the outlet as it exits the downstream end; (c) a solvent application mechanism downstream of the upstream end for applying solvent to the mat; and (d) a basin under at least a portion of the conveyor for collecting solvent and debris falling from the mat.

### BRIEF DESCRIPTION OF DRAWINGS

FIG. 1 shows a perspective view of one embodiment of a cleaning system of the invention having an angled conveyor system for infeeding the mat.

FIGS. 1a shows a side view schematic of a similar embodiment of the cleaning system of FIG. 1.

FIGS. 1b-1d are cross sections of the apparatus of FIG. 1a along various points of the conveyor belt.

FIG. 2 is an alternative embodiment of the cleaning apparatus of the present invention having multiple conveyors in a horizontal configuration.

FIG. 3 is a schematic views of one embodiment of the conveyor with a conveyor belt.

FIG. 4 is a schematic view of a configuration of discrete narrow conveyors on each side to leave the middle open.

FIG. 5 is a side cross sectional view of the embodiment of FIG. 1.

### DETAILED DESCRIPTION

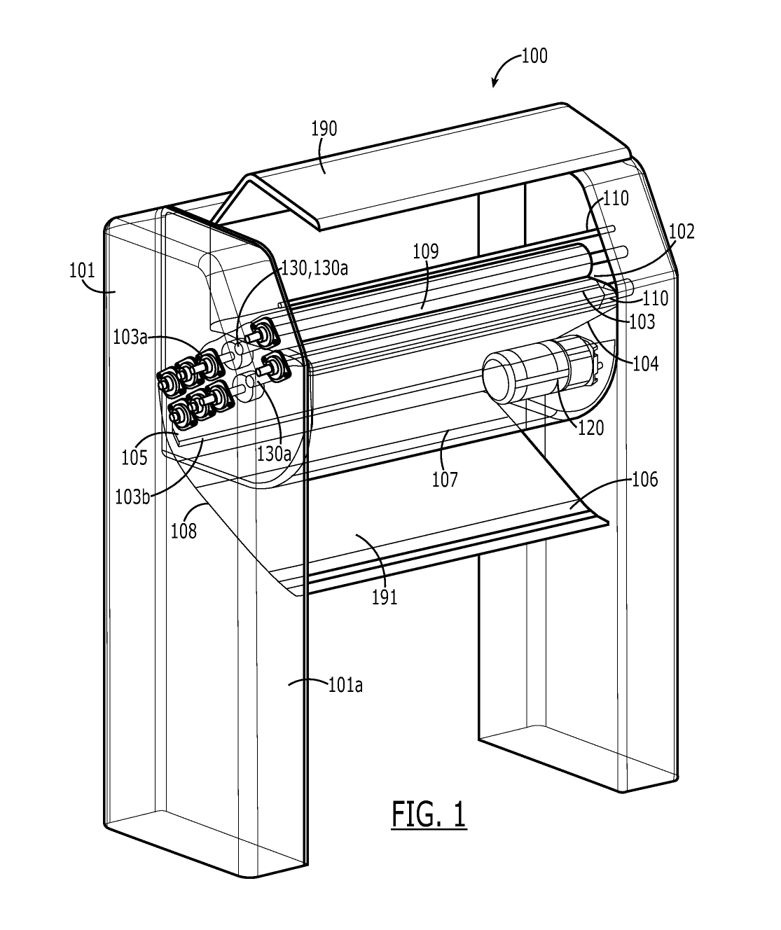

Referring to FIGS. 1 and 1a, a perspective view and a schematics view of similar embodiments of a cleaning system 100 of the present invention are shown. For illustrative purposes, the system 100 is described in the context of cleaning a yoga mat 150, although the present invention may be applied to clean any mat which is compliant and periodically requires cleaning.

The cleaning system 100 comprises a housing 101 having a top and bottom orientation and a front face 101a defining at least an inlet 102. The system 100 also comprises at least one conveyor 103 in the housing 101 having an upstream and downstream orientation and having an upstream end 104 disposed at the inlet 102. The conveyor is configured to draw the mat 150 into the housing edge-wise through the inlet 102. The conveyor also has a downstream end 105 positioned in relation to an outlet 106 such that the mat 150 is channeled though the outlet as it exits the downstream end 105. Downstream of the upstream end 104 along the conveyor 103 is a solvent application mechanism 110 for applying solvent (not shown) to the mat 150. The system 100 also comprises a basin 107 under at least a portion of the conveyor 103 for collecting solvent and debris falling from the mat 150. These elements will now be considered in greater detail.

The housing 101 functions to cover and support the various components of the mat cleaning apparatus including the conveyor, various motors, guides, basin, etc. The inlet 102 and the outlet 106 are defined in the housing. The inlet 102, in one embodiment, is defined as a relatively narrow slot on the front face 101a of the housing 101 configured to allow the mat 150 to be inserted therein edgewise, whereupon it is grabbed by the conveyor and drawn in as described below. In one embodiment, the outlet 106 is also defined on the front face 101a of the housing. Having the inlet and outlet on the same face of the housing has certain benefits as it allows the user to insert the mat in the inlet and simply wait there until the mat is ejected through the outlet, as opposed to, moving to a different position of the housing to receive the mat as it is ejected from the machine.

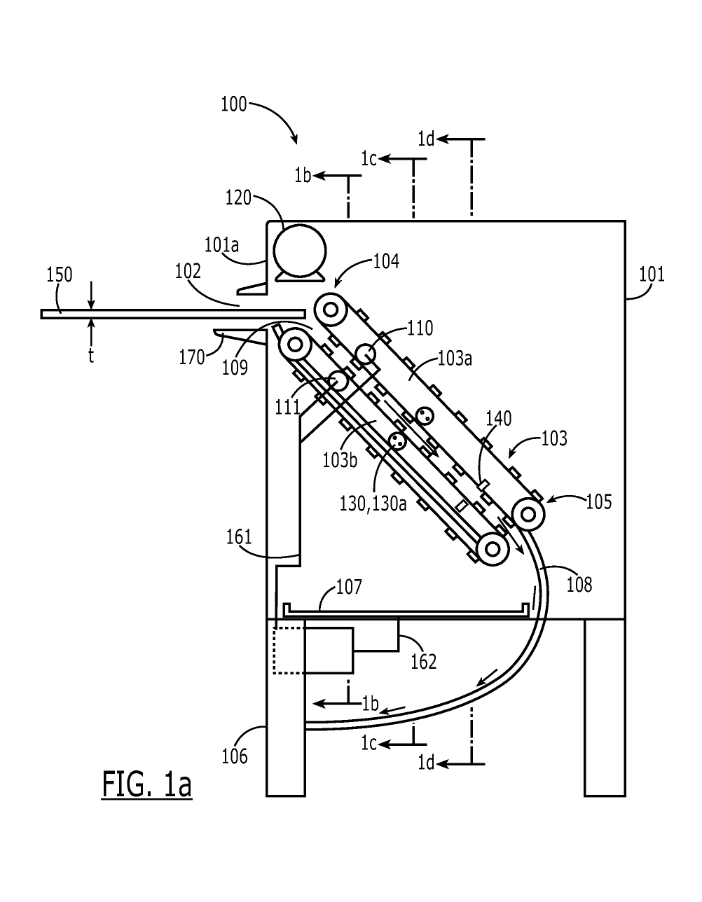

Although FIGS. 1, 1a, and 2 depict the inlet and the outlet as being defined in the same common front face of the housing, it should be understood that other embodiments are possible. For example, the outlet may be on the opposite side of the housing relative to the inlet. Such an embodiment may be preferred from a simplicity standpoint as it allows the mat to move in a linear fashion without the need to bend to make turns. Still other embodiments will be obvious in light of this disclosure.

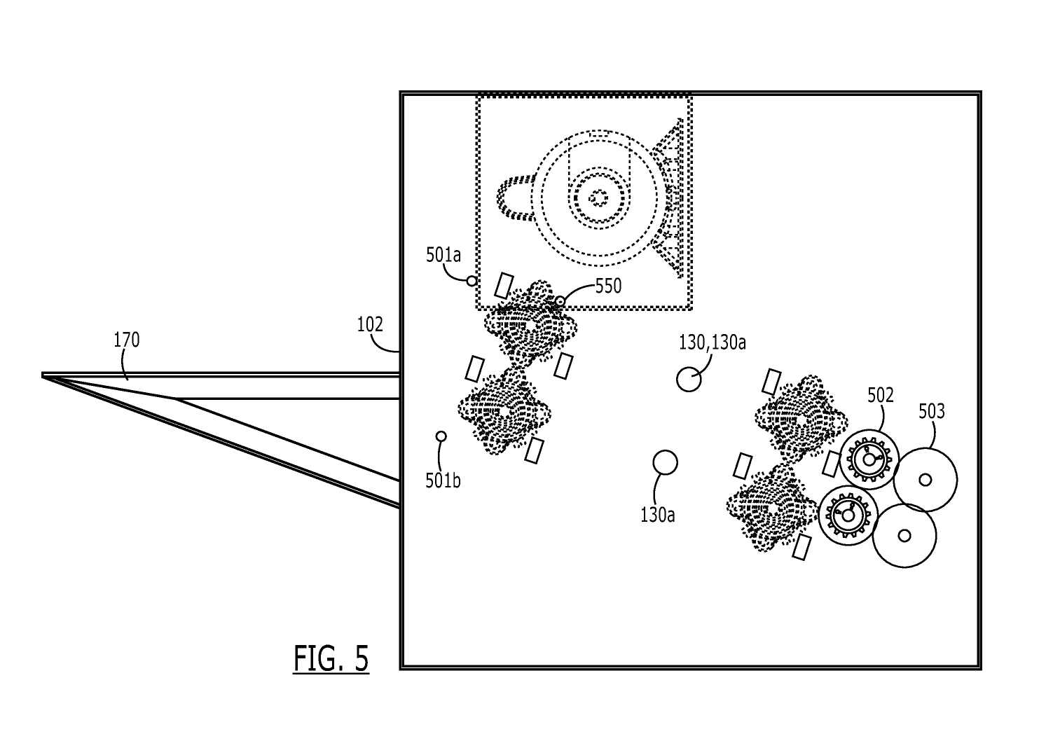

In one embodiment, the inlet comprises a shelf 170 on which to rest the mat as it is being drawn through the inlet 102 (See FIGS. 1a and 5). Likewise, the outlet 106 may contain a shelf 270 (see FIG. 2) or bin 191 (FIG. 1) to hold or catch the mat as it is ejected from the system.

In one embodiment, the housing 101 comprises a lid 190 which can be opened for access to the conveyor 103. (The lid is shown in its open position in FIG. 1.) In one embodiment, the lid is interconnected with the conveyor 103 such that, when the lid 190 is opened, it spreads the upper and lower portions of the conveyor apart to allow a user to extract a mat in the conveyor in the event of a malfunction, jam, or power loss.

An important feature of the invention is the conveyor 103. The conveyor may have various configurations. For example, the conveyor 103 may be a series of rollers, a series rollers with a conveyor belt, multiple series of rollers with conveyor belts, one or more rollers that pushes/pulls the mat through stationary guide(s), or even a clamp that grips the front or leading edge of the mat and that is pulled or otherwise moved through the machine while gripping the mat. (The clamp may be, for example, a mechanical clamp, adhesive clamp, suction clamp, or magnetic clamp. A clamp used in this fashion may also function to keep the mat straight while it is fed through the machine). Still other configurations will be known to those of skill in the art in light of this disclosure.

In one embodiment, the conveyor has an upstream and downstream orientation, with an upstream end 104 and a downstream end 105. The upstream end is proximate the inlet 102 such that, when a user inserts the mat 150 into the inlet 102 edgewise, the conveyor 103 grabs the mat and draws it into the housing. To assist in the initial grabbing of the mat, in one embodiment, the conveyor comprises a nip comprising rubber rollers.

The downstream end may be proximate to the outlet such that, as the mat exits the conveyor, it is immediately pushed through the outlet 106. Such an embodiment of the system 200 is shown in FIG. 2. Specifically, the conveyor 203 has an upstream end 204 proximate the inlet 202 and a downstream end 205 proximate the outlet 206. Alternatively, as shown in the embodiment of FIGS. 1 and 1a, the conveyor 103 is disposed diagonally in the housing such that the downstream end 105 is a distance away from the outlet 106. For example, the axis of conveyor system 103 can be disposed at about 45 degrees from the axis of the mat entering cleaning system 100 at inlet 102. In such an embodiment, it may be preferred, although not necessary to use a guide 108 to guide the mat 150 from the downstream end 105 to the outlet 106.

The conveyor system 103 may comprise one or more discrete conveyors for gripping the mat firmly, but without damaging it, and guiding the mat through cleaning system. For example, in the embodiments shown in FIGS. 1 and 1a, the conveyor 103 comprises top and bottom conveyors 103a, 103b configured to receive the mat therebetween. Specifically, the top and bottom conveyors 103a, 103b define a nip 109 which is slightly narrower than the thickness (t) of the mat 150 such that, when the user inserts the mat into the inlet 102 and into the nip 109, the conveyors grab the mat and pull it into the housing 101 for cleaning.

Other conveyor configurations are possible. For example, referring to the system 200 shown in FIG. 2, the conveyor 203 comprises a top conveyor 203a, one or more intermediate conveyors 203b, and a bottom conveyor 203c. As shown in FIG. 2, the top conveyor 203a and one of the intermediate conveyors 203b are configured to receive the mat 150 therebetween and define the upstream end 204. The bottom conveyor 203c and one of the intermediate conveyors 203b are configured to receive the mat therebetween and define the downstream end 205. In FIG. 2 only one intermediate conveyor 203b is shown, although it should be understood that other embodiments may include multiple intermediate conveyors, such that one intermediate conveyor is dedicated to the top conveyor 203a and another is dedicated to the bottom conveyor 203c. For example, in some embodiments (not shown), conveyor system 103 may include four conveyors such one intermediate conveyor is dedicated to the top conveyor 203a and another intermediate conveyor is dedicated to the bottom conveyor 203c.

In the embodiment of FIG. 2, it may be desirable, although not necessary, for the system 200 to comprise a guide 208 disposed at ends of the top and bottom conveyors 203a, 203c distal from the upstream and downstream ends 204, 205, respectively. The guide 208 is configured to guide the mat from between the top conveyor 203a and the one of the intermediate conveyors 203b to between the bottom conveyor 203c and the one of the intermediate conveyors 203b. In this particular embodiment, the guide 208 is configured with essentially an 180 degree bend.

As mentioned above, the embodiment of FIG. 2 depicts a configuration in which the conveyor 203 comprises a common intermediate conveyor 203b. Such an embodiment, has certain advantages. For example, it is simple as the top of the intermediate conveyor 203b functions as the bottom conveyor for the top conveyor 203a, while the bottom of the intermediate conveyor 203c function as the top conveyor for the bottom conveyor 203c.

It should be understood that although that a common intermediate conveyor is shown in FIG. 2, multiple intermediate conveyors may be used such that one intermediate conveyor is dedicated to the top conveyor while a second intermediate conveyor is dedicated to the bottom conveyor. Such an embodiment may be preferred from the standpoint of avoiding interconnecting the top and bottom conveyors 203a, 203c through the mat 150. That is, as the mat 150 goes from the top conveyor to the bottom, it will tend to link the two conveyors together requiring to some degree that the conveyors be synchronized. Although such synchronization is readily achieved, if the speeds are not properly matched it the interaction between the top and bottom conveyor may cause the mat to buckle or stretch. Accordingly, in some applications, it may be preferred to use multiple intermediate conveyors to allow the top and bottom conveyors to run more autonomously.

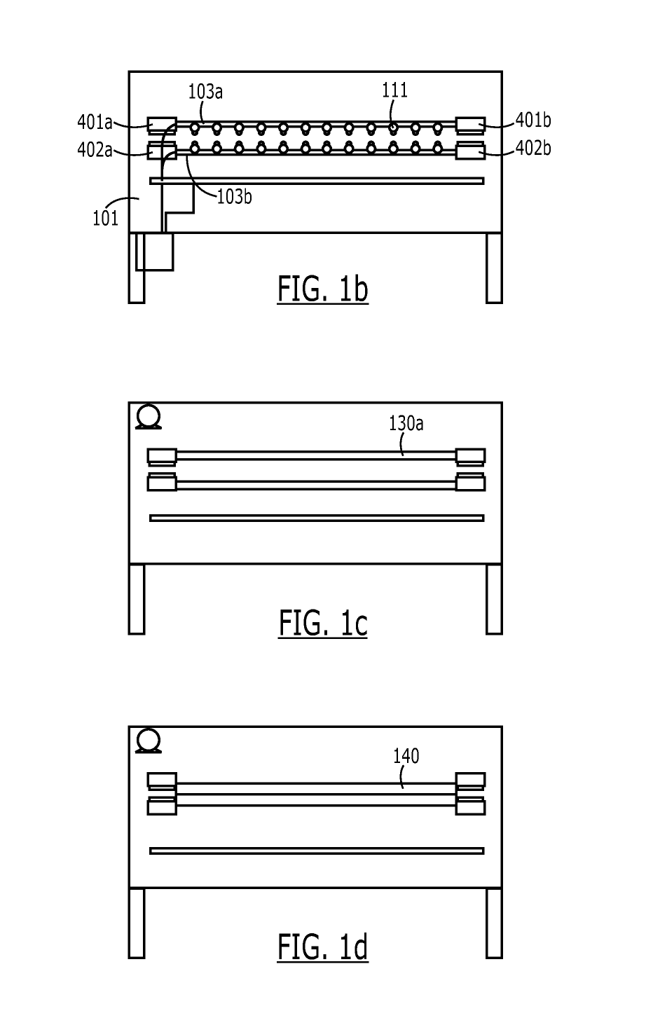

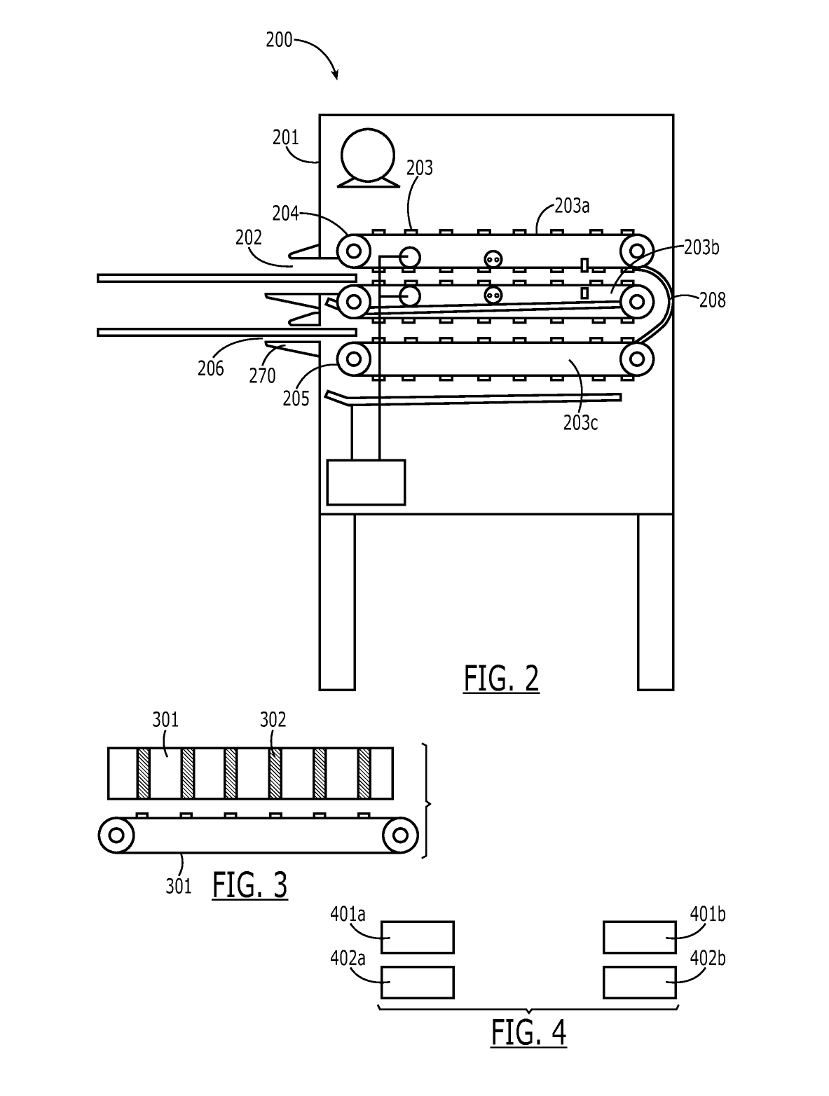

The conveyor 103 may comprise one or more belts which may have a variety of embodiments. In one embodiment, conveyor system 103 includes a poly mesh belt that is sufficiently rigid to support the mat, but will not wear the mat surface. Also, the mess configuration of the belt allows fluids and light to reach the mat between the conveyors 103a, 103b. If a poly mesh belt is used, the rollers may be configured with teeth or protrusions 550 (see FIG. 5) to engage the opening in the mesh and thereby grip the belt. In one embodiment, the width of the poly mesh belt is substantially same as the width of the mat. The belts hold the mat firmly while allowing access to UV light and liquid spray from above and below. These full width belts keep the mat inline and help prevent jamming. In another embodiment, as shown in FIG. 3, the belt 301 comprises knobs 302 to enhance the grip on the mat. In yet another embodiment, each conveyor may comprise a number of discrete conveyors. For example, referring to FIG. 4, a head on view of the conveyor 403 is shown in which the top and bottom conveyors comprise two narrow conveyors 401a, 401b and 402a, 402b, respectively. Narrow conveyors 401a, 401b are on each side of the top conveyor, and narrow conveyors 402a, 402b are on each side of the bottom conveyor such that the middle is open space.

In another embodiment, the conveyor system 103 comprises a series of rollers the grip the mat and pulled through the cleaning system. This embodiment of the conveyor does not require a belt.

In one embodiment, the conveyor 103 is powered by a motor 120 as shown in FIGS. 1 and 1a. The motor is preferably selected to run on residential voltage such as 120 VAC such that the system 100 may be simply plugged into an ordinary outlet. In one embodiment, the same motor controls all the conveyors. For example, a gear train or chain may be used to interconnect the motor 120 with the various rollers in the conveyor 103. Such an embodiment has the advantage of ensuring that the conveyors are synchronized. It should be understood however that the invention is not limited to such an embodiment and one or more dedicated motors may be used for each conveyor.

In one embodiment, the same motor not only powers the conveyor, but also powers the other mechanism of the system 100 such as the scrubbing apparatus and the solvent application system 110 described below.

The solvent application system 110 may be disposed anywhere along the conveyor 103, although, preferably, it is disposed toward the upstream end 104 of the conveyor, as shown in FIGS. 1 and 1a, before the mat comes in contact with a physical cleaning device, such that the solvent will have more time to interact with the mat and remove the debris as is well known in the solvent/cleaning art. Such a configuration also avoids the problem of applying the solvent through the conveyor. Nevertheless, in certain embodiments, it may be preferable to position the solvent application system 110 downstream of the inlet.

As shown in FIG. 1, the solvent application system 110 comprises spray nozzles 111 which spray the solvent. In the embodiment of FIGS. 1 and 1a, the spray nozzles 111 are disposed on either side of the mat (see FIG. 1b). In some applications, it may be preferred that the rate of solvent application is controlled to prevent soaking or saturating the mat. In such applications, solvent can be applied in the form of a fine mist light enough not to soak or saturate a mat that is made of a porous material. This ensures that a mat exiting the cleaning system 100 is not only sanitized and clean, but also dry enough to be rolled. Accordingly, in some embodiments, the solvent is stored in a reservoir tank and sprayed onto the mats from above and below via misting nozzles mounted on manifolds 501a and 501b, as shown in FIG. 5. The manifold can be a bar style manifold located above and below the mat, perpendicular to the axis of the mat, and having a length substantially equal to the width of the mat (see FIG. 5). The size and location of the reservoir allows for fewer and convenient refills. A pump is used to transfer the cleaning solvent from the reservoir to the nozzles mounted on the manifold. For example, cleaning solvent can be transferred from the reservoir to the manifold using a 0.3 gpm pump that operates on 120 VAC power sources. Alternatively, rather than a pump, a compressed air system may be used. The manifold and spray nozzle can be adjusted to obtain a desired outflow of the cleaning solvent. In one embodiment, sizing of the spray nozzle can be adjusted to obtain a mist.

In one embodiment, to further control and limit the amount of solvent applied to the mat, the solvent is applied using known ionization and/or humidification systems. Additionally, in one embodiment, to reduce mat saturation, a vacuum system is disposed near the solvent application system to extract the solvent from the mat before it is absorbed by the mat.

In one embodiment, the solvent application system is configured to apply force to the mat to aid and dislodge debris. Likewise, in one embodiment, a scrubbing apparatus is used to enhance the interaction of the solvent with the direct/debris in the mat. Such scrubbing apparatus are known to one of skill in the art in light of this disclosure. For example, in one embodiment, rotating scrub brushes are used which have an axis of rotation essentially perpendicular to the mat's surface. In such a configuration, it may be beneficial to position the brushes on opposite sides of the mat to stabilize the mat. Also, in one embodiment, the rotating brushes rotate in different directions such as to neutralize and lateral force applied by the brush to the mat. In another embodiment, the scrubbing apparatus comprise rotary brushes which have an axis of rotation essentially parallel to the mat's surface. The rotation of the brushes can aid in moving the mat through the cleaning system. Still other embodiment will be obvious to those of skill in the art in light of this disclosure.

In one embodiment, the solvent comprises an antimicrobial agent which is well known in the art. In such an embodiment, the solvent therefore not only functions to remove dirt and debris from the mat, but also functions to sanitize the mat.

In addition to or as an alternative to using an antimicrobial agent in the solvent, the system may be augmented with an irradiation source 130 to expose the mat to electromagnetic radiation having a wavelength and intensity sufficient to kill microbes. Suitable eradiation sources include, for example, UV light. In one embodiment, as shown in FIGS. 1, 1a and 2, UV lamps 130a are disposed on either side of the mat in the conveyor. Although the lamps are shown disposed downstream of the solvent application system, the irradiation source may be upstream of the solvent system. Irradiation power of the lamps and placement of the lamps can be varied for optimal eradication of microbes on the mat.

In one embodiment, the system 100 further comprises a solvent removal system which may have different embodiments. For example, as mentioned above, the solvent removal system may comprise a vacuum system. Alternatively, in one embodiment, the solvent removal system comprises one or more wipers 140 as shown in FIG. 1 and FIG. 1d to wipe the solvent from mat causing the wiped solvent to fall into the basin. In another embodiment, one or more driers may be used to enhance drying of the mat. For example, in one embodiment, the driers are blowers (heated or non-heated) disposed at the downstream end of the conveyor. In another embodiment, the blowers function not only to dry the mat, but also to kill microbes using heat, thereby enhancing the system's antimicrobial functionality. In one embodiment, the mat exiting the conveyor system 103 is then fed through brush rollers 502 and two natural rubber rollers 503, as shown in FIG. 5, to press out any liquid in the mat and leave the surface with a tacky feel. In another embodiments, removal of solvent is accomplished by applying an upper and lower squeegees to the mat exiting the conveyor system 103. In some embodiments, the squeegees are mounted on rotating brackets with springs. The springs allow the squeegee to apply desired pressure on the mat. The thickness and length of the squeegees can be varied for optimal removal of solvent from the mat. The pressure and angle at which the squeegees contact can also be varied for optimal removal of solvent from the mat. Still other solvent removal approaches will be obvious to one of skill in the art in light of this disclosure.

In one embodiment, the basin 107 is operatively connected to a solvent collector 160 through a drain 162. The solvent collector 160 may serve simply as a repository for used solvent. Alternatively, in one embodiment, the solvent collector 160 serves to collect solvent for recycling. To this end, the solvent collector 160 is connected to the solvent application system 110 through a feed line 161. If the solvent is recycled in the system 100 then a filter generally, although not necessarily, is preferred. The filter removes the dirt and debris from the used solvent. The filter may be disposed in a variety of locations including at the drain 162, in the solvent collector 160, at the feed line 161. If the solvent is recycled, it is generally preferred, although not necessary, that the solvent contain a biocide to ensure that bacteria are not transmitted between mats.

Embodiments of the cleaning system 100 can further include a process logic control (PLC) system for safe operations of the cleaning system 100 and to prevent damage to the cleaning system 100. More specifically, the PLC system can control the drive motor, fluid application, UV lighting, access panels, fluid levels, and run time. For example, in one embodiment, the PLC is interconnected with sensors (not shown) placed along the inlet 102 to determine when a user has inserted the edge of a mat into the system. Once the edge of the mat is detected, the PLC starts the motor to activate the conveyor to pull the mat into the system. In one embodiment, multiple sensors are used along the width of the inlet 102 to ensure that the edge of a wide mat is being detected and not a hand.

The PLC system can also allow the machine to be reversed when a jam occurs. The PLC system control of access panel switches can prevent machine operation if a user opens the front hood or any other part of the machine. Additional sensors can be used to alert users that fluid level is low, collection level is full, or any additional aspects of the machine that are not functioning correctly. The PLC system can also be used to control and vary the angle at which the squeegee contacts with the mat and the pressure the squeegee applies to the mats. Suitable PLCs are well known in the art and commercially available.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

What is claimed is:

1. A system for cleaning porous mats, said system comprising:
a housing having a top and bottom orientation and having a front face defining at least an inlet;
at least one conveyor in said housing having an upstream and downstream orientation and having an upstream end disposed at said inlet, said conveyor configured to draw said mat into said housing edge-wise, said conveyor having a downstream end positioned in relation to an outlet such that said mat is channeled though said outlet as it exits said downstream end;
a solvent application mechanism downstream of said upstream end for applying solvent to said mat; and
a basin under at least a portion of said conveyor for collecting solvent and debris falling from said mat.

2. The system of claim 1, wherein said front face also defines said outlet.

3. The system of claim 1, wherein said housing is on wheels.

4. The system of claim 1, wherein said downstream end is proximate said outlet.

5. The system of claim 1, further comprising: a guide disposed at said downstream end of said conveyor to guide said mat to said outlet.

6. The system of claim 5, wherein said conveyor is disposed diagonally in said housing.

7. The system of claim 1, wherein said conveyor comprises top and bottom conveyors configured to receive said mat therebetween.

8. The system of claim 7, further comprising a guide disposed at ends of said top and bottom conveyors distal from said upstream and downstream ends, respectively, said guide configured to guide said mat from said conveyor to said outlet.

9. The system of claim 1, wherein said conveyor comprises a belt.

10. The system of claim 9, wherein said belt comprises a poly mesh belt.

11. The system of claim 10, wherein conveyor comprises rollers having teeth to grip said belt.

12. The system of claim 1, wherein said conveyor comprises rollers and no belt.

13. The system of claim 1, wherein said solvent comprises a biocide to kill microbes in said mat.

14. The system of claim 1, further comprising:
an irradiation source downstream of said inlet for exposing said mat to a electromagnetic radiation of a wavelength and intensity sufficient to kill microbes

15. The system of claim 1, further comprising a solvent removal system.

16. The system of claim 1, wherein said basin is operatively connected to a solvent collector

17. The system of claim 16, further comprising conduit connecting said solvent application mechanism to said solvent collector.

18. The system of claim 1, wherein said inlet comprises a shelf to rest said mat on as it is being drawn through said inlet.

19. The system of claim 1, further comprising a scrubbing apparatus.

20. The system of claim 19 in which the conveyor and scrubbing apparatus are driven by a common motor.
